(19) United States
(12) Patent Application Publication
(10) Pub. No.: US 2022/0051286 A1
(43) Pub. Date: Feb. 17, 2022

(54) TRANSMITTING DIGITAL OFFERS OPTIMIZED FOR TRANSMISSION MEDIUM

(71) Applicant: QUOTIENT TECHNOLOGY INC., Mountain View, CA (US)

(72) Inventors: VIPUL RASIKLAL BHARAKHADA, Milpitas, CA (US); TAO FENG, San Jose, CA (US); KSHAMA SHIVAJI PAWAR, Fremont, CA (US); RATIKA PRASAD, Bangalore (IN); SANJAY SIDDAPPA, Bangalore (IN); JINGYU ZHOU, San Jose, CA (US)

(21) Appl. No.: 17/085,227

(22) Filed: Oct. 30, 2020

(30) Foreign Application Priority Data
Aug. 14, 2020 (IN) 202011035120

(51) Int. Cl. G06Q 30/02

(52) U.S. Cl. CPC G06Q 30/0238; G06Q 30/0239

(57) ABSTRACT

A computer system and computer-implemented method for receiving digitally stored metadata that defines a digital offer including specifying one or more static components and one or more dynamic components; for each of the static components, pre-computing a digital image in an interim raw byte representation and digitally storing the interim raw byte representations corresponding to all the static components; in response to receiving a request to provide a digital offer in real-time on demand: retrieving the interim raw byte representations corresponding to all the static components; for each of the dynamic components, rendering a component image file in real-time on demand; joining the interim raw byte representations corresponding to all the static components and all the component image files corresponding to the dynamic components and creating and storing a single digital image file corresponding to the digital offer; and transmitting the single digital image file to another computer.

### RELATED APPLICATION

This application claims the benefit of India Patent Application No. 202011035120 filed Aug. 14, 2020, the entire contents of the previous application is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2019-2020 Quotient Technology, Inc.

### FIELD OF THE DISCLOSURE

One technical field of the present disclosure is computer-implemented methods and formats of transmitting digital data between server computers and client computers. Another technical field is transformation of digitally stored data elements from one format to another format with interim caching.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Client-server distributed computer systems are widely used to process data at a server computer and transmit the data to a client computer that is located remotely with respect to the server computer. In some applications, the client computer must receive data, process data, and generate output rapidly; these are termed low-latency applications. Users or other systems involved in these applications often have a low tolerance for processing delays, and there is a need to configure client computer operation to be as efficient as possible. In other cases, other kinds of transmission media may be used to communicate offers to users, and the specific transmission medium for a particular customer may have different constraints.

One example application is processing sales transactions, in which a server computer holds or manages data that is needed to complete a transaction, and a point-of-sale (POS) terminal and POS peripherals provide data output to a seller or customer. For example, the server computer may generate, store or manage the storage of inventory data, price data, or data representing offers such as coupons. Some such systems have been programmed to generate inventory, price or offer data at the server computer location dynamically, in real-time as a consumer transaction occurs. Some such systems begin a transaction at the retailer, process the transaction including creating local storage of the details of a consumer purchase or basket, request data for offers from the server computer, and print or present the offer data after the server computer responds.

However, these systems cannot operate with a necessary or practical level of speed and efficiency if data from the server computer takes too long, at the server computer, to generate or return. There is a need to minimize the time for processing server-side data so that the total time of local request, server processing, server response, and printing or other presentation is as short as possible. In some cases, providers of digital offers are subject to service level agreement (SLA) that limit the time between a request for an offer, receiving an offer, and printing the offer; if the SLA is not met by the offer provider, the POS terminal is programmed to skip or drop printing a coupon or offer. Dropped prints waste CPU cycles, network bandwidth and other resources that are consumed when requests are transmitted without resulting in a successful printing of an offer. In present practice, there also is no simple or efficient means to personalize or customize digital offers with elements or attributes that are targeted to the medium of delivery, user device type, and individual user segments, and there is a need for more efficient data transmission approaches that can support improvements in these areas.

### SUMMARY

The appended claims may serve as a summary of the invention.

### BRIEF DESCRIPTION OF THE DRAWINGS

In the drawings:

FIG. 1A illustrates a distributed computer system that may be used to implement one embodiment.

FIG. 1B illustrates a graphical example of a digital offer such as a coupon.

FIG. 2 illustrates a flow diagram of a process that may be programmed as part of one embodiment.

FIG. 3 illustrates alternative steps that can be used in another embodiment of the process of FIG. 2.

FIG. 4 illustrates a digital offer such as a coupon in schematic form, showing its parts.

FIG. 5 illustrates a computer system with which an embodiment can be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described in sections according to the following outline:
1. GENERAL OVERVIEW
2. EXAMPLE DISTRIBUTED COMPUTER SYSTEM
3. EXAMPLE DIGITAL OFFER IMAGE GENERATING PROCESS
4. IMPLEMENTATION EXAMPLE—HARDWARE OVERVIEW

### 1. General Overview

In an embodiment, the disclosure provides an efficient way to create a customized coupon image that is targeted towards the medium of delivery. In some cases, the coupon image can be personalized or targeted to individual user segments. The efficiency of the disclosed approaches enables more personalization and customization, supporting uses that were not possible earlier with a reasonable response time. In various embodiments, customization can be provided at the device level or user account level, customized according to the medium of delivery, and personalized according to the user with different dynamic and static content. Templates can be personalized to reuse static data combined with dynamic data. Personalized templates are possible due to the efficiency of data transmission that is provided in the disclosed approach, because some required aspects of computation cannot execute efficiently at the client. The disclosed approaches can be applied to grayscale images as well, to reduce network bandwidth. In this manner, customization for the delivery medium, or based on capabilities of the delivery medium, is made possible.

In an embodiment, the disclosure provides a computer-implemented method, comprising receiving digitally stored metadata that defines a digital offer including specifying one or more static components and one or more dynamic components; for each of the static components, pre-computing a digital image in an interim raw byte representation and digitally storing the interim raw byte representations corresponding to all the static components; in response to receiving a request to provide a digital offer in real-time on demand: retrieving the interim raw byte representations corresponding to all the static components; for each of the dynamic components, rendering a component image file in real-time on demand; joining the interim raw byte representations corresponding to all the static components and all the component image files corresponding to the dynamic components and creating and storing a single digital image file corresponding to the digital offer; transmitting the single digital image file to another computer; wherein the method is performed by one or more computing devices. Examples of static components and dynamic components are provided in other sections below.

In another aspect, the disclosure provides a computer system, comprising: an offer server computer comprising one or more processors coupled to non-transitory computer-readable storage media storing static element pre-compute instructions and dynamic image generation instructions, and comprising cache storage and coupled to an offer database; the offer server computer being communicatively coupled to one or more offer printers that are associated with a point of sale; the static element pre-compute instructions being configured, when executed by the offer server computer, to cause the offer server computer to execute: receiving digitally stored metadata that defines a digital offer including specifying one or more static components and one or more dynamic components; for each of the static components, pre-computing a digital image in an interim raw byte representation and digitally storing the interim raw byte representations corresponding to all the static components; the dynamic image generation instructions being configured, when executed by the offer server computer, to cause the offer server computer to execute: in response to receiving a request to provide a digital offer in real-time on demand: retrieving the interim raw byte representations corresponding to all the static components; for each of the dynamic components, rendering a component image file in real-time on demand; joining the interim raw byte representations corresponding to all the static components and all the component image files corresponding to the dynamic components and creating and storing a single digital image file corresponding to the digital offer; transmitting the single digital image file to another computer.

Additional features, aspects and embodiments will become apparent from the following description. the drawing figures, and other parts of the disclosure as a whole.

### 2. Example Distributed Computer System

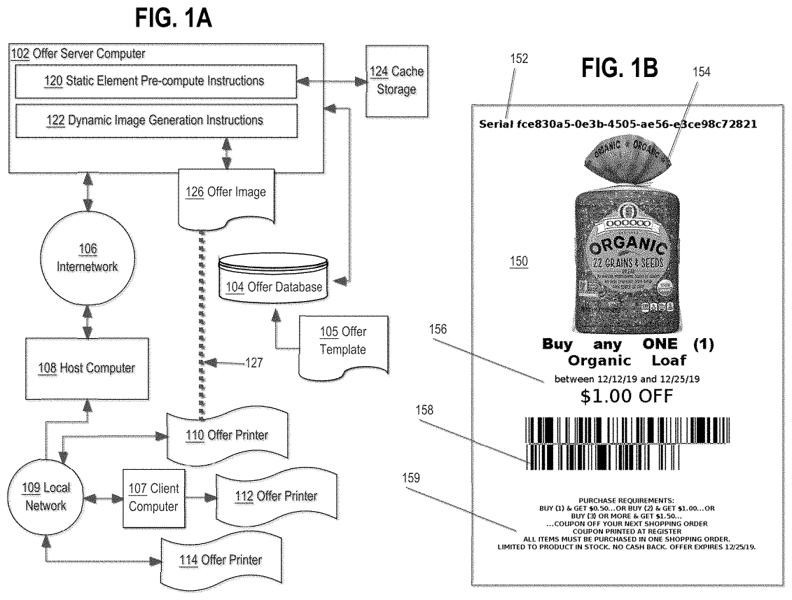

FIG. 1A illustrates a distributed computer system that may be used to implement one embodiment. FIG. 1A, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

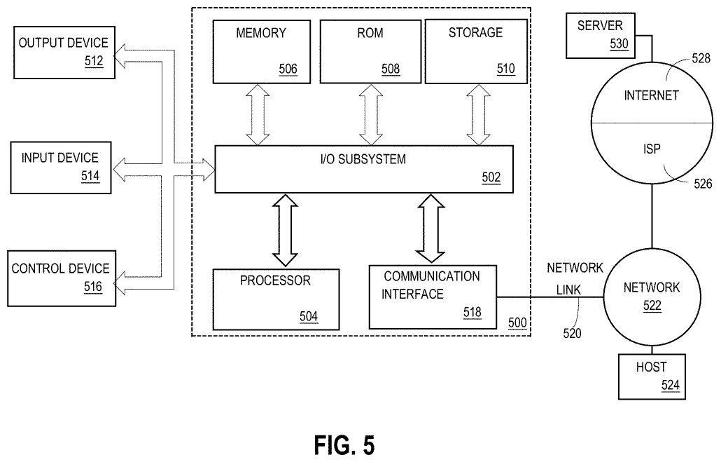

In FIG. 1A, an offer server computer 102 is coupled via internetwork 106 to host computer 108. illustrates a distributed computer system that may be used to implement one embodiment. Offer server computer 102 may comprise a mainframe computer, minicomputer, other class of server computer, or one or more virtual machine instances or clusters of a datacenter or online cloud computing system or facility. The specifications, in terms of CPU power, memory, network interfaces and storage, of offer server computer 102 may vary according to the number of concurrent connections that the offer server computer needs to support and, in general, these specifications are not critical and can be readily determined by IT professionals to support thousands of connections and millions of transactions in a given time. The computer system of FIG. 5 may be used to implement one embodiment of offer server computer 102.

In an embodiment, offer server computer 102 is coupled to an offer database 104 that is programmed to digitally store offer data. In an embodiment, each offer is defined in at least record of a table of a relational database in which columns define attributes such as campaign, brand, product or SKU, start date, end date, value, one or more conditions or other purchase requirements, territory or geography, retailer or channel, or other limitations or terms. In an embodiment, offer database 104 further stores a plurality of offer templates 105 that may be retrieved, populated with offer-specific data, and stored as specific offers.

In an embodiment, offer server computer 102 is communicatively coupled to cache storage 124, which may be programmed to store and retrieve digital image files, raw data for images or text, or other data structures and elements as further described. Cache storage 124 may be implemented in main memory of offer server computer 102, or in separate storage. In one embodiment, cache storage 124 is a REDIS cache.

In an embodiment, offer server computer 102 further comprises static element pre-compute instructions 120 and dynamic image generation instructions 122. The instructions 120, 122 comprise sets of executable program instructions which, when executed using a CPU or processor of the offer server computer 102, cause the offer server computer to perform the functions that are described further herein in other sections.

Internetwork 106 broadly represents one or more local area networks, wide area networks, internetworks, internets or a combination thereof that are configured or programmed to communicate digital data between offer server computer 102 and host computer 108. The public internet may be used in combination with one or more LANs or WANs and with configuration of security protocols such as HTTPS over TCP/IP.

In an embodiment, a host computer 108 is coupled to internetwork 106 and to a local network 109, which is communicatively coupled to one or more client computers 107 and/or to one or more offer printers 110, 112, 114. In other embodiments, host computer 108 and/or client computers 107 are omitted. In various embodiments, host computer 108 is associated with a retailer entity, a retailer site, or a retailer store and acts as a controller and multiplexer for communications between the offer server computer 102 and a large number of offer printers or client computers at one or more stores or sites.

In an embodiment, the client computer 107 provides local computing and control functions such as point-of-sale (POS) functions. The client computer 107 may be a POS terminal that is coupled to an offer printer 122, or a controller of a plurality of POS terminals or printers. Or, offer printers 110, 114 may be programmed to receive and print offers without a client computer 107 as an interface. The selection of an architecture or architectures from among the foregoing options may be determined based upon the capabilities or interface requirements of specific offer printers 110, 112, 114 that are used in different setups. In one embodiment, one or more of the offer printers 110, 112, 114 comprises a paper receipt printer capable of printing documents about 2 in. (7 cm) wide by 4.5 in (12.5 cm) at 200 dpi.

As further described in other sections, in operation, the static element pre-compute instructions 120 and dynamic image generation instructions 122 are programmed to use an offer template 105, or digital offer data stored in offer database 104, to form a digital image file denoted offer image 126 that is transmitted via internetwork 106 and local network 109 to one of the offer printers, such as offer printer 110. Line 127 indicates a logical path of movement of the offer image 126 from offer server computer 102 to offer printer 110.

FIG. 1B illustrates a graphical example of a digital offer such as a coupon. In an embodiment, a digital offer 150 comprises a unique serial number 152, a product image 154, first text 156 specifying first offer terms, a barcode 158, and second text 159 specifying second offer terms. FIG. 1B illustrates the nature and arrangement of example offer data which, in one embodiment, is formed in a single digital image file for transmission to an offer printer. In an embodiment, each element of FIG. 1B is an offer component, and each offer component may be associated with a sub-image comprising digital image data that is concatenated or stitched into a complete offer image using the operations described further in other sections.

### 3. EXAMPLE DIGITAL OFFER IMAGE GENERATING PROCESS

### 3.1 OVERVIEW

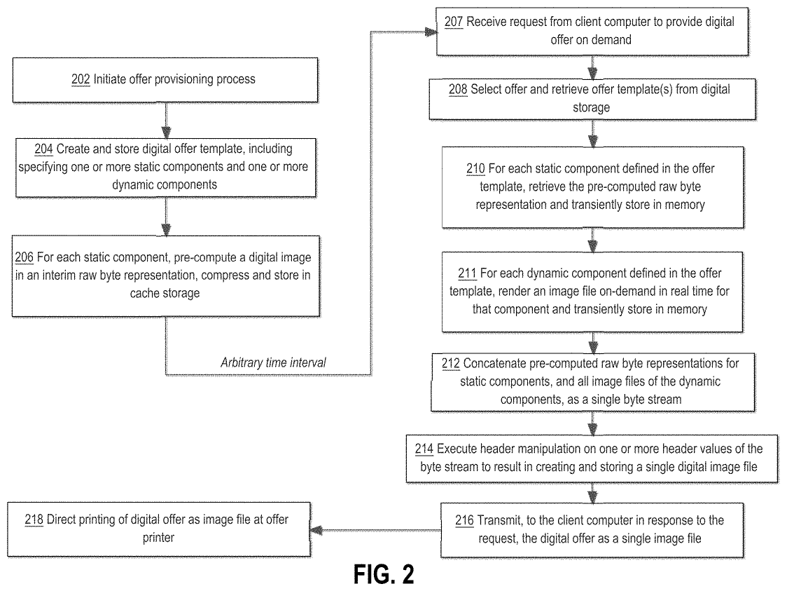

FIG. 2 illustrates a flow diagram of a process that may be programmed as part of one embodiment. FIG. 2 and each other flow diagram herein is intended as an illustration at the functional level at which skilled persons, in the art to which this disclosure pertains, communicate with one another to describe and implement algorithms using programming. The flow diagrams are not intended to illustrate every instruction, method object or sub-step that would be needed to program every aspect of a working program, but are provided at the same functional level of illustration that is normally used at the high level of skill in this art to communicate the basis of developing working programs.

In an embodiment, at operation 202, an offer provisioning process is initiated. For example, operation 202 executes when a new offer is created or defined, or when an existing offer is updated or edited. An offer provisioning process may comprise a user account interacting with a graphical user interface that provides means for creating digital data values that represent terms of an offer and persistently storing a digital data record in offer database 104 that represents the offer.

In an embodiment, at operation 204, the process executes to create and store a digital offer template. Each digital offer is defined using a template comprising one or more static components and one or more dynamic components. Static components do not change when, in response to a request from the POS, specific instances of digital offers are rendered from the template and delivered to the POS. Dynamic components are generated and rendered on-demand or in real time, and typically specify data elements that must be different for each specific instance of a digital offer, such as a serial number or barcode. In some embodiments, the static components and/or the dynamic components may be stored as metadata, in whole or in part, in database records for offers or campaigns.

An example of a static component is a digital image file which, when rendered, provides a digital image of a product, such as an item of consumer packaged goods (CPGs). Another example is digitally stored text specifying offer terms or conditions, such as “Buy ONE (1) Abc Brand Organic Loaf.” Static components may define discount values, effective dates of an offer, territory, retailer or other attributes of an offer. Static components are termed “static” because the components do not change when multiple instances of an offer are generated or printed; these components could be used thousands or millions of time during a campaign. In an embodiment, the static components comprise title, description, logo, barcode, disclaimer. In other embodiments, barcode may be a dynamic component. In some embodiments, the balance of static components to dynamic components may vary in embodiments depending on the size of the components; for example, dynamic components can be limited to relatively smaller components that can be rapidly rendered, and larger components can be static and pre-computed. Or, dynamic components can be formed based on functional requirements, such as the need to present a changing expiration date or a unique serial number. Dynamic content also can be personalized content.

In an embodiment, at operation 206, for each static component, the process pre-computes a digital image in an interim raw byte representation. The raw byte representation is compressed and stored in cache storage, such as cache storage 124. In an embodiment, JAVA byte arrays may be used for the raw byte representation. Operation 206 has the benefit of preparing, at a time before an offer is generated at real-time at the point of sale, digital data that can be used to rapidly render a graphic image of the static components.

After operation 206, an arbitrary time interval may elapse, as indicated in FIG. 2 by an arrow connecting operation 206 to operation 207. In an embodiment, operations 202, 204, 206 represent a pre-processing phase that may execute without time constraints or time requirements, as campaigns, templates and digital offers are created and stored. The pre-processing phase results in creating and storing digital data that can form a basis for rapid, real-time and on-demand generation of digital image files for complete digital offers that combine the static components and dynamic components using the interim raw byte representation. In an embodiment, the static element pre-compute instructions 120 of FIG. 1A may be programmed to execute operations 202, 204, 206.

In an embodiment, after an arbitrary time interval, at operation 207 the process receives a request from a client computer to provide a digital offer on-demand and/or in real time. Typically, operation 207 executes when the offer server computer 102 receives a request from host computer 108, client computer 107 or an offer printer when a consumer is at the POS and/or when a merchant or retailer is handling a transaction and about to print a receipt or otherwise complete a transaction. In this context, on-demand, or real-time, may refer to generating and returning a digital offer in as little processing time as possible to enable printing the offer at the point of sale when the scanning of a consumer's basket of goods is complete, and before an electronic or paper transaction is complete. As a practical matter, most consumers are willing to wait, after goods have been scanned and bagged, or after payment, only a second or two to receive a digital offer. Therefore, an express goal of the present process is to complete operation 207 to operation 218 within about one second.

Operation 207 broadly represents receiving, at an offer server computer such as computer 102, a request to return a digital offer to any other computer or device. In various embodiments, operation 207 may comprise receiving a request from any of host computer 106, client computer 107, or offer printers 110, 112, 114, depending on whether those elements have processors and executable programs that can issue requests and process offers that are received.

At operation 208, the process selects an offer, and retrieves an offer template from digital storage. Selecting an offer may use any of many techniques known in the art. Offers may be selected randomly, or based on geographical data, location data, or consumer loyalty card data that is received in a request. Or, a request may identify or summarize the goods in a consumer's basket at the POS, and offer server computer 102 may select offers based on compatibility with the goods, seasonality, or other factors. The specific algorithm or metrics used for selecting an offer is not critical to the present disclosure.

Retrieving an offer template at operation 208 may comprise the offer server computer 102 transmitting a SELECT query to offer database 104 to obtain a particular offer template 105. It will be remembered that each offer template 105 defines one or more static components and one or more dynamic components. At operation 210, for each static component defined in the offer template, the process retrieves the pre-computed raw byte representation and transiently stores the data in main memory. Importantly, this step does not require rendering because the raw byte representation is directly usable in a digital image file to represent the static components, which later can be graphically and visually printed correctly from the resulting file at the offer printer. The result is a substantial savings in time, CPU cycles and other processing resources to generate a printed offer at the POS.

At operation 211, for each dynamic component defined in the offer template, the process renders a component sequence of bytes into memory on-demand in real time for that component. As examples, operation 211 may comprise requesting, retrieving and/or generating numeric or alphanumeric values for digital data to be represented in an offer serial number and/or barcode, then rendering digital graphic image file data corresponding to the serial number and/or barcode. The specific values represented in these components normally will be different each time that operation 211 executes, so that each instance of an offer has a unique identifier and/or barcode.

Image bytes for the dynamic components may be rendered directly into the cache storage and then inserted into byte sequences corresponding to the static components. In an embodiment, at operation 212, the process joins the pre-computed raw byte representations for static components with all component image files for the dynamic components that were just generated, and outputs a single byte stream. Operation 212 may comprise concatenating or stitching the elements in memory and then writing a single digital image file to memory, or local storage, in a specified digital image format such as PNG, JPEG, or TIFF.

At operation 214, the process executes header manipulation on one or more header values of the byte stream to result in creating and storing a complete single digital image file. Header manipulation may comprise programmatic action to directly modify one or more values in the header of the digital image file. For example, the header values for image width and height can be rewritten to cause an offer printer to use a specified image area for printing.

At operation 216, the process transmits, to the client computer or other requesting element, the digital offer as a single image file. In an embodiment, operation 216 comprises forming and transmitting an HTTP POST message in which a PNG file is referenced in the payload.

In an embodiment, the dynamic image generation instructions 122 of FIG. 1A may be programmed to execute operation 207 to operation 216, inclusive.

At operation 218, the digital offer is printed as an image file at an offer printer. Operation 218 may occur automatically under control of software executed at the host computer 108, client computer 107, or one of the offer printers of FIG. 1.

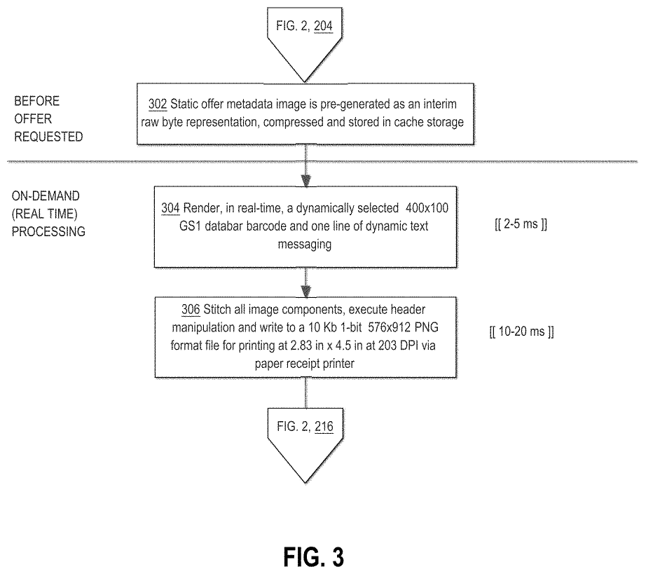

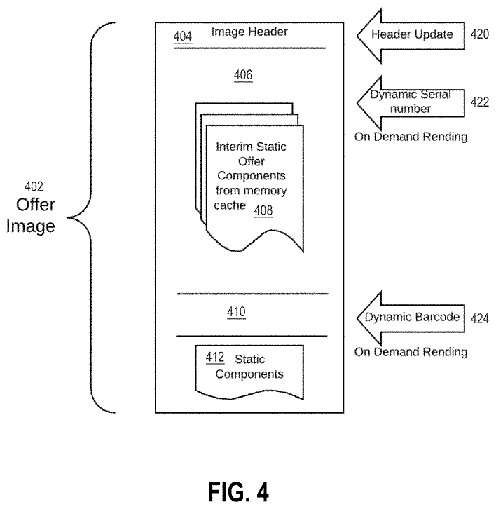

FIG. 3 illustrates alternative steps that can be used in another embodiment of the process of FIG. 2. FIG. 4 illustrates a digital offer such as a coupon in schematic form, showing its parts. Referring first to FIG. 3, in one embodiment, operations 202, 204 of FIG. 2 are performed. Thereafter, at operation 302, which is executed before the offer server computer 102 receives a request for an offer from the POS, a static offer metadata image is pre-generated as an interim raw bye representation, compressed and stored in cache storage. For example, cache storage 124 may be used.

Thereafter, on-demand (real-time) processing occurs, for example, in response to a request from the POS at operation 207 of FIG. 2. At operation 304, the process renders, in real-time, a bar code and text messaging. For example, in one embodiment, the process renders scannable data, such as a dynamically selected 400x100 GS1 databar barcode, and one line of dynamic text messaging. Testing by the inventors has shown that this operation requires only about 2-5 milliseconds (ms) using server hardware of ordinary capability.

At operation 306, the process stitches all image components together, executes header manipulation and writes the resulting data to a digital image file of about 10 Kb size, with 1-bit 576x912 pixel PNG format for printing at 2.83 in×4.5 in at 203 DPI via a paper receipt printer.

Referring now to FIG. 4, in an embodiment, an offer image 402 as represented in a digitally stored file may comprise an image header 404. In an embodiment, a header update 420 may rewrite or update values in the image header 404. A dynamic serial number 422 may be stored in region 406 of the offer image during an on-demand rendering stage; FIG. 1B shows an example of a serial number 152 in a rendered digital offer 150. Static offer components 408 may be added to the offer image 402 from cache storage 124 where they were previously stored in an interim raw byte representation. Examples include a product image 154, first text 156 specifying first offer terms (FIG. 1B).

A dynamic barcode 424 may be added at a region 410 as part of the same on-demand rendering stage, for example, barcode 158 of FIG. 1B. Other static components 412 may be included in the offer image 402 as well. An example of other static components 412 is second text 159 specifying second offer terms (FIG. 1B).

### 3.2 Targeted Offers Based on Efficient Processing

Execution of operation 306 needs about 10-20 ms using server hardware of ordinary capability. Thus, the total time to generate a digital offer image file, once the offer has been requested and selected, is only about 12-25 ms. The overhead involved in receiving offer requests, preparing and dispatching responses, and transmitting over networks has been found to be insignificant. However, the disclosed process has been found to substantially reduce the time to render and return a digital image file representing an offer for printing.

In contrast, other approaches may have used print systems with software to reconstruct various data components to print a coupon, including components such as images, text and bar codes. In some cases, all components are text, with attributes identifying fonts, font sizes, and other rendering attributes to be implemented at the printer. The software on the printing systems redirects various components to the appropriate sections within the coupon, to ready it for printing. This method imposes overhead on the printing process because the software must execute operations to map coupon data components to parts of the coupon for printing. For example, the inventors have observed, in experiments, overhead of at least 100 ms to 200 ms for full image generation at printers using the JAVA 2D library. This overhead is believed to arise from the processing and printing of offer metadata elements one by one, each as a new content item or image. Furthermore, in high-overhead approaches, all items need be generated at runtime; image processing is known to be an execution-heavy operation. For example, for a logo thumbnail image, a processor must be programmed to decompress data from the raw logo image, add it to the image canvas with the text images and bar code image rendered separately and then compress all of it again to output the end image.

This overhead impacts the overall service level agreement (SLA) for POS terminals to print the receipt and coupon together, resulting in dropped coupon prints if the SLAs are not met. The same approach can create security loopholes since the various components are typically not encrypted. For example, the text components could be read or manipulated to allow a malicious part to modify the contents or discount offered in the offer. By transmitting the offer as an image file, these fields are not as susceptible to manipulation, and therefore the disclosed approach provides a significant improvement in security compared to other approaches.

The present disclosure dramatically reduces digital coupon print times by generating a full coupon image at the offer server computer and transmitting the image file to the printer for printing directly as an image. The overhead of mapping components during print time is eliminated and a significant performance improvement is achieved from operations that stitch an interim pre-processed byte stream directly with smaller dynamic content streams through image header manipulation to transmit a fully formatted coupon image. While some overhead is introduced at the stage of image creation, the time impact is far less. It will be apparent from the foregoing that the present disclosure is capable of returning digital image files for offers in significantly reduced time compared to the other approaches that have been described.

In some embodiments, offer printers are not used, and client computer 107 may comprise a mobile computing device without a printer. In this embodiment, the client computer 107 may be programmed with an application (app) that is compatible with offer server computer 102. The app may implement an offer request call or function that transmits an offer request to the offer server computer 102 using an app protocol message over HTTP. In response, the offer server computer 102 may transmit dynamic coupons as images via MMS messages or e-mail messages back to the client computer 107. This allows for faster and personalized offers through incorporating dynamic content for each mobile computing device.

The efficiencies achieved by the techniques disclosed herein enable programming the generation and delivery of digital offers in new ways. In some embodiments, the techniques herein are implemented using other kinds of printers to print personalized coupons. Or, the techniques herein can be used to free up server-side processing time to permit generating digital offers with more personalization and customization, supporting use cases that could not be supported using earlier techniques while still providing a reasonable response time. Customization can be implemented at the device level or user level, and/or customized based on the communication channel or the medium of delivery, and/or personalized per user of dynamic and static content. The offer templates also can be personalized to reuse interim data combined with dynamic data. These kinds of targeting and personalization are possible because of the efficiency of the means of generating offers that has been described in earlier sections.

In various embodiments, because digital offers as described herein include dynamic components, and are generated using a highly efficient approach, each particular digital offer may be customized based on the customer or shopper. In an embodiment, the system is programmed to execute generating a customized digital offer based on digitally stored data concerning the customer or shopper that has been previously obtained. For example, the techniques herein may be integrated with retail store POS systems that are capable of scanning a store loyalty card at the POS, retrieving a database record having columns that store attributes of the customer or shopper, which the customer or shopper previously provided. This customer data may be transmitted to the offer server computer 102 for use in dynamically forming an offer.

Examples of dynamically composed offers may include:

A digital offer 150 may use different typography and different image contrast values dependent on the age of the shopper.

A digital offer 150 may use dynamic components consisting of different images that are selected based on the gender of the shopper.

A digital offer 150 may use different images that are selected based on whether the person is a parent.

A digital offer 150 may use different images, text, or wording that is selected based on the age of the shopper, or based on the shopper's generation or age demographic in a band or segment, such as millennial, Gen Z, older audience, or middle-aged. These attributes also can be used to select and use different offer pricing.

A digital offer 150 may use different images, text, or wording that are selected based on stored data representing a lifestyle attribute of the person, such as brand conscious, lifestyle choices, or value over savings.

A digital offer 150 may use different images or image size based on the demographics or location of the user.

A digital offer 150 may use different images based on the customer's past purchases, activations, or redemptions.

A digital offer 150 may use different images based on time.

A digital offer 150 may use different images based on the user's cookies or browsing events.

A digital offer 150 may be served by MMS messaging, email, or a printer at the POS. Based on digitally stored data specifying the delivery channel, product image 154, other attributes of the digital offer 150, or the entire image resulting from the use of the complete process described herein, may be different. For example, the size or resolution of the product image 154, or the entire image resulting from the use of the complete process described herein, could vary based on the transmission channel.

The specific means for executing and implementing the dynamic construction of digital offer 150 based upon data about a customer or shopper, as described above, will be known to those of skill in the relevant art. Many other dynamic forms of constructing a digital offer 150 are possible, and the details of the underlying data, its sources, decisions about what data is relevant, and the effect of data values on dynamic values, of which examples are given above, is not critical to an embodiment. Instead, the efficient means of forming a digital offer 150 using static components and dynamic components, and transmitting the result in a single image format as described for various embodiments above, makes it possible to implement any of the dynamic construction examples given above in server-side instructions, because of the added time that is available with the efficiency of the present approaches.

4. IMPLEMENTATION EXAMPLE—HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

FIG. 5 illustrates a computer system with which an embodiment can be implemented.

Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated-services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method, comprising:
receiving digitally stored metadata that defines a digital offer including specifying one or more static components and one or more dynamic components;
for each of the static components, pre-computing a digital image in an interim raw byte representation and digitally storing the interim raw byte representations corresponding to all the static components;
in response to receiving a request to provide a digital offer in real-time on demand:
retrieving the interim raw byte representations corresponding to all the static components;
for each of the dynamic components, rendering a component image file in real-time on demand;
joining the interim raw byte representations corresponding to all the static components and all the component image files corresponding to the dynamic components and creating and storing a single digital image file corresponding to the digital offer; and
transmitting the single digital image file to another computer, wherein the method is performed by one or more computing devices.

2. The method of claim 1, further comprising:
creating and storing a digital offer template based on the digitally stored metadata that defines a digital offer including specifying one or more static components and one or more dynamic components; and
in response to the request to provide a digital offer in real-time on demand, selecting and retrieving the digital offer template and using the digital offer template to identify the one or more static components and the one or more dynamic components before the rendering.

3. The method of claim 1, further comprising:
digitally storing the interim raw byte representations corresponding to all the static components in cache storage; and
in response to receiving the request to provide a digital offer in real-time on demand, retrieving the interim raw byte representations corresponding to all the static components from the cache storage.

4. The method of claim 1, wherein the joining comprises any of concatenating or stitching the pre-computed raw byte representations and the component image files and writing the single digital image file in any of PNG, JPEG, or TIFF digital image file formats.

5. The method of claim 1, further comprising:
receiving the request to provide the digital offer in real-time on demand from a client computer that is associated with a point of sale, the point of sale having an offer printer;
creating and storing the single digital image file corresponding to the digital offer using an image width and image height that are capable of direct printing by the offer printer; and
transmitting the single digital image file to the client computer associated with the point of sale for the direct printing by the offer printer.

6. The method of claim 1, further comprising:
receiving the request to provide the digital offer in real-time on demand from a point of sale terminal having a receipt printer;
creating and storing the single digital image file corresponding to the digital offer using an image width and image height that are capable of direct printing by the receipt printer; and
transmitting the single digital image file to the point of sale terminal for the direct printing by the receipt printer.

7. The method of claim 1, further comprising executing header manipulation on the single digital image file.

8. The method of claim 1 wherein, for each of the dynamic components, rendering the component image file in real-time on demand comprises rendering digital image component files for two or more of: a dynamically generated barcode, a dynamically generated serial number, or a dynamic text messaging.

9. The method of claim 1, further comprising:
in response to receiving a request to provide a digital offer in real-time on demand, executing within 2 milliseconds: retrieving the interim raw byte representations corresponding to all the static components, and for each of the dynamic components, rendering the component image files in real-time on demand; and
executing within 20 milliseconds: joining the interim raw byte representations corresponding to all the static components and all the component image files corresponding to the dynamic components and creating and storing a single digital image file corresponding to the digital offer; transmitting the single digital image file to another computer.

10. A computer system, comprising:
an offer server computer comprising one or more processors coupled to non-transitory computer-readable storage media storing static element pre-compute instructions and dynamic image generation instructions, and comprising cache storage and coupled to an offer database;
the offer server computer being communicatively coupled to one or more offer printers that are associated with a point of sale;
the static element pre-compute instructions being configured, when executed by the offer server computer, to cause the offer server computer to execute:
receiving digitally stored metadata that defines a digital offer including specifying one or more static components and one or more dynamic components;
for each of the static components, pre-computing a digital image in an interim raw byte representation and digitally storing the interim raw byte representations corresponding to all the static components;
the dynamic image generation instructions being configured, when executed by the offer server computer, to cause the offer server computer to execute:
in response to receiving a request to provide a digital offer in real-time on demand:
retrieving the interim raw byte representations corresponding to all the static components;
for each of the dynamic components, rendering a component image file in real-time on demand;
joining the interim raw byte representations corresponding to all the static components and all the component image files corresponding to the dynamic components and creating and storing a single digital image file corresponding to the digital offer; and
transmitting the single digital image file to another computer.

11. The computer system of claim 10, the offer database storing a plurality of digital offer templates, each digital offer template being based on the digitally stored metadata that defines a digital offer including specifying one or more static components and one or more dynamic components, the computer system further comprising instructions which when executed cause, in response to the request to provide a digital offer in real-time on demand, selecting and retrieving the digital offer template and using the digital offer template to identify the one or more static components and the one or more dynamic components before the rendering.

12. The computer system of claim 10, further comprising instructions which when executed cause digitally storing the interim raw byte representations corresponding to all the static components in cache storage; and in response to receiving the request to provide a digital offer in real-time on demand, retrieving the interim raw byte representations corresponding to all the static components from the cache storage.

13. The computer system of claim 10, further comprising instructions which when executed cause the joining by any of concatenating or stitching the pre-computed raw byte representations and the component image files, and writing the single digital image file in any of PNG, JPEG, or TIFF digital image file formats.

14. The computer system of claim 10, further comprising instructions which when executed cause:
receiving the request to provide the digital offer in real-time on demand from a client computer that is associated with a point of sale, the point of sale having an offer printer;
creating and storing the single digital image file corresponding to the digital offer using an image width and image height that are capable of direct printing by the offer printer; and
transmitting the single digital image file to the client computer associated with the point of sale for the direct printing by the offer printer.

15. The computer system of claim 10, further comprising instructions which when executed cause:
receiving the request to provide the digital offer in real-time on demand from a point of sale terminal having a receipt printer;
creating and storing the single digital image file corresponding to the digital offer using an image width and image height that are capable of direct printing by the receipt printer; and
transmitting the single digital image file to the point of sale terminal for the direct printing by the receipt printer.

16. The computer system of claim 10, further comprising instructions which when executed cause executing header manipulation on the single digital image file.

17. The computer system of claim 10, further comprising instructions which when executed cause, for each of the dynamic components, rendering the component image file in real-time on demand comprises rendering digital image component files for two or more of: a dynamically generated barcode, a dynamically generated serial number and a dynamic text messaging.

18. The computer system of claim 10, further comprising instructions which when executed cause:
in response to receiving a request to provide a digital offer in real-time on demand, executing within 2 milliseconds: retrieving the interim raw byte representations corresponding to all the static components, and for each of the dynamic components, rendering the component image files in real-time on demand; and
executing within 20 milliseconds: joining the interim raw byte representations corresponding to all the static components and all the component image files corresponding to the dynamic components and creating and storing a single digital image file corresponding to the digital offer; transmitting the single digital image file to another computer.

19. A non-transitory computer-readable medium storing software comprising instructions executable by one or more computers which, upon such execution, cause the one or more computers to perform operations comprising:
receiving digitally stored metadata that defines a digital offer including specifying one or more static components and one or more dynamic components;
for each of the static components, pre-computing a digital image in an interim raw byte representation and digitally storing the interim raw byte representations corresponding to all the static components;
in response to receiving a request to provide a digital offer in real-time on demand:
retrieving the interim raw byte representations corresponding to all the static components;
for each of the dynamic components, rendering a component image file in real-time on demand;
joining the interim raw byte representations corresponding to all the static components and all the component image files corresponding to the dynamic components and creating and storing a single digital image file corresponding to the digital offer; and
transmitting the single digital image file to another computer.

20. The computer-readable medium of claim 19, the operations further comprising:
creating and storing a digital offer template based on the digitally stored metadata that defines a digital offer including specifying one or more static components and one or more dynamic components; and
in response to the request to provide a digital offer in real-time on demand, selecting and retrieving the digital offer template and using the digital offer template to identify the one or more static components and the one or more dynamic components before the rendering.
